(19) United States
(12) Patent Application Publication
(10) Pub. No.: US 2014/0002524 A1
(43) Pub. Date: Jan. 2, 2014

(54) CORRECTING WEB SKEW IN A PRINTING SYSTEM

(71) Applicants: Christopher M. Muir, Rochester, NY (US); Randy E. Armbruster, Rochester, NY (US); Thomas Niertit, Webster, NY (US); Brad Smith, Xenia, OH (US); Timothy J. Hawryschuk, Miamisburg, OH (US); James M. Enge, Spencerport, NY (US); Daniel J. DeVivo, Dayton, OH (US)

(72) Inventors: Christopher M. Muir, Rochester, NY (US); Randy E. Armbruster, Rochester, NY (US); Thomas Niertit, Webster, NY (US); Brad Smith, Xenia, OH (US); Timothy J. Hawryschuk, Miamisburg, OH (US); James M. Enge, Spencerport, NY (US); Daniel J. DeVivo, Dayton, OH (US)

(21) Appl. No.: 13/536,216

(22) Filed: Jun. 28, 2012

(51) Int. Cl. B41J 29/38

(52) U.S. Cl. 347/14

(57) ABSTRACT

A printing system can include a movable support and a linehead disposed on the movable support. The linehead is positioned opposite a print media and jets ink onto a surface of the print media. One or more linehead skew adjustment mechanisms are configured to move the movable support to adjust a skew of the linehead. The printing system can include an imaging system that captures images of the surface of the print media and a processing device that analyzes the images to determine if the print media is skewed and to determine one or more linehead skew adjustment values when the print media is skewed.

### CROSS-REFERENCE TO RELATED APPLICATION

This patent application is related to U.S. patent application Ser. No. ______ (Docket K000383), entitled “CORRECTING WEB SKEW IN A PRINTING SYSTEM” filed concurrently herewith.

### TECHNICAL FIELD

The present invention generally relates to printing systems and more particularly to a method for correcting web skew and front-to-back registration in a printing system.

### BACKGROUND

Continuous web printing allows economical, high-speed, high-volume print reproduction. In this type of printing, a continuous web of print media or a support mechanism in which the print media is disposed over is fed past one or more printing modules that form images by applying one or more colorants onto the surface of the print media. Various components within a printing system are used to create tension in the web so the web does not shift in the in-track and cross-track directions as the web moves through the printing system. The tension is also used to inhibit fluttering (up or down motion) as the web travels through the printing system.

FIG. 1 illustrates a desired position for a web of print media in a printing system. The print media 100 is positioned in a cross track direction so as to maintain center justification of the print media 100 within a media operation zone 102. Typically, the center line 104 of the print media is maintained within acceptable tolerances relative to a device that is performing an operation on the print media while the print media is traveling through the media operation zone 102. The device that is performing an operation on the print media can be a linehead 106 that jets ink onto the print media or a dryer (not shown) that dries the ink. When the center line 104 of the print media is maintained within acceptable tolerances, a print line jetted by each linehead 106 is straight in the cross-track direction and all of the print lines 108 are parallel with respect to each other.

FIG. 2 depicts web skew in a printing system. The print media 100 is not positioned in a cross-track direction so as to maintain center justification of the print media 100 within the media operation zone 102. Instead, the print media 100 is skewed in the cross-track direction such that the centerline 104 of the print media is non-linear and curves with respect to the transport direction of the print media. When the center line 104 of the print media is not maintained within acceptable tolerances, the print line lines 200 jetted by the lineheads 106 are not parallel with respect to each other. Web skew can cause the color planes that are printed on the print media to be misaligned with respect to each other.

Web skew can be caused by one or more factors, including non-linear accuracy of web edge sensors that position the web in the cross track direction, web camber, or misalignment of rollers through the media operation zone 102. Web skew can cause significant delay in the setup of the printing system. In order to make corrections, operators of the printing system must manually evaluate web skew via eye-loop measurements of printed output. The operator must then manually change web servo setpoints to make the necessary corrections to web skew, which is often an iterative process.

### SUMMARY

According to one aspect, a printing system includes a movable support and a linehead disposed on the movable support. The linehead is positioned opposite a print media and jets ink onto a surface of the print media. One or more linehead skew adjustment mechanisms are configured to move the movable support to adjust a skew of the linehead. The printing system can include an imaging system that captures images of the surface of the print media. The printing system can include a processing device that analyzes the images captured by the imaging system to determine whether the print media is skewed and to determine one or more linehead skew adjustment values when the print media is skewed.

According to another aspect, a printing system includes a linehead that jets ink onto a surface of the print media, an imaging system that captures images of the surface of the print media, and one or more linehead skew adjustment mechanisms adapted to adjust the skew of the linehead. A method for correcting for skew in a print media in the printing system includes capturing images of one or more test marks printed or formed on the print media and analyzing the images to determine whether the print media is skewed with respect to a transport direction of the print media. If the print media is skewed, one or more linehead skew adjustment values is determined to adjust a skew of the linehead. The skew of the linehead is adjusted based on the one or more linehead skew adjustment values. Prior to determining the one or more linehead skew adjustment values to adjust a skew of the linehead, a determination can be made as to whether the skew of the print media equals or exceeds a threshold value. The one or more linehead skew adjustment values are determined if the skew of the print media equals or exceeds a threshold value.

### BRIEF DESCRIPTION OF THE DRAWINGS

Embodiments of the invention are better understood with reference to the following drawings. The elements of the drawings are not necessarily to scale relative to each other. Like numbers indicate like parts throughout the views.

FIG. 1 illustrates a top view of a desired position for a web of print media in a printing system;

FIG. 2 depicts a top view of web skew in a printing system;

FIG. 3 is a schematic side view of one example of a continuous web printing system in an embodiment in accordance with the present invention;

FIG. 4 depicts a portion of the printing system 300 shown in FIG. 3 in more detail;

FIG. 5 illustrates an example of an arrangement of the printheads in a linehead in an embodiment in accordance with the invention;

FIG. 6 is a flowchart of a method for correcting web skew in a printing system in an embodiment in accordance with the invention;

FIG. 7 is a graphical illustration of a web in an embodiment in accordance with the invention;

FIGS. 8-9 illustrate examples of the skew of the lineheads in a printing system after correcting for web skew in an embodiment in accordance with the invention;

FIG. 10 depicts one example of the skew degree of freedom for the lineheads in a printing system in an embodiment in accordance with the invention; and

FIG. 11 illustrates an example of a linehead and a linehead skew adjustment mechanism in an embodiment in accordance with the invention.

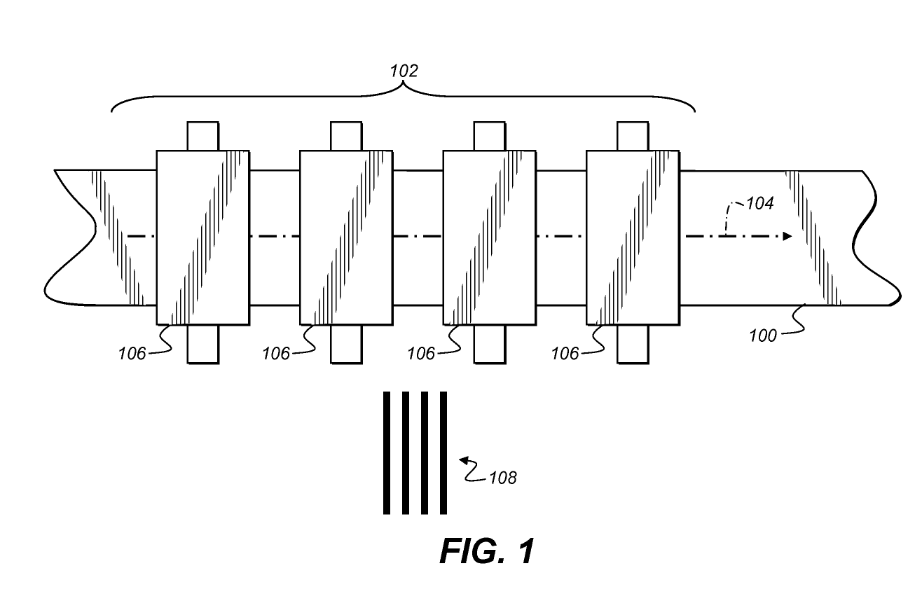

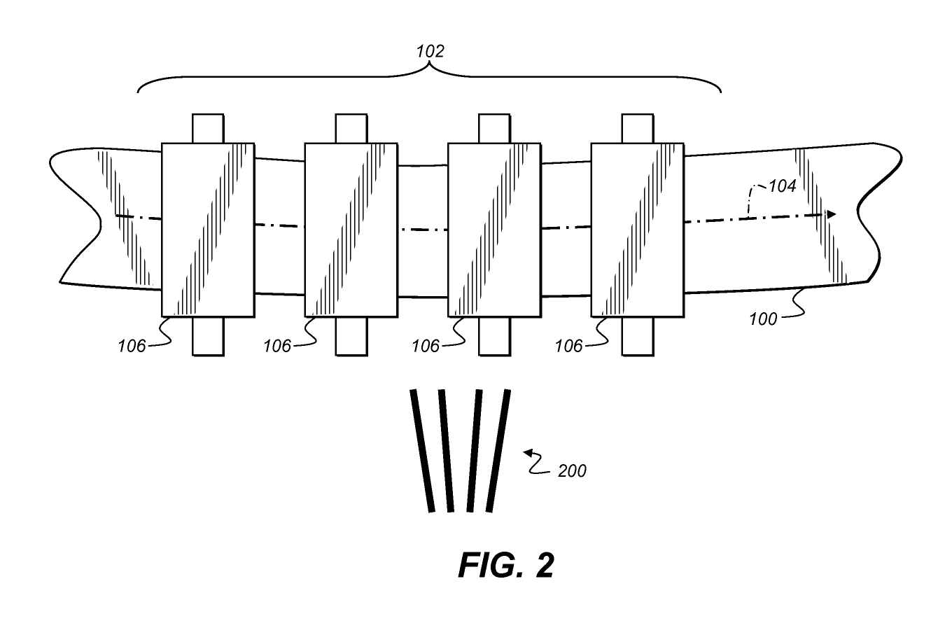

### DETAILED DESCRIPTION

Throughout the specification and claims, the following terms take the meanings explicitly associated herein, unless the context clearly dictates otherwise. The meaning of “a,” “an,” and “the” includes plural reference, the meaning of “in” includes “in” and “on.”Additionally, directional terms such as “on”, “over”, “top”, “bottom”, “left”, “right” are used with reference to the orientation of the Figure(s) being described. Because components of embodiments of the present invention can be positioned in a number of different orientations, the directional terminology is used for purposes of illustration only and is in no way limiting.

The present description will be directed in particular to elements forming part of, or cooperating more directly with, an apparatus in accordance with the present invention. It is to be understood that elements not specifically shown, labeled, or described can take various forms well known to those skilled in the art. In the following description and drawings, identical reference numerals have been used, where possible, to designate identical elements. It is to be understood that elements and components can be referred to in singular or plural form, as appropriate, without limiting the scope of the invention.

The example embodiments of the present invention are illustrated schematically and not to scale for the sake of clarity. One of ordinary skill in the art will be able to readily determine the specific size and interconnections of the elements of the example embodiments of the present invention.

As described herein, the example embodiments of the present invention apply to correcting web skew as the web is transported through a printing system. The web can be the print media or a support mechanism that is routed through the printing system. Inkjet printing is commonly used for printing on paper, where paper is the print media. However, there are numerous other materials in which inkjet is appropriate. For example, vinyl sheets, plastic sheets, textiles, paperboard, and corrugated cardboard can comprise the print media. Additionally, although the term inkjet is often used to describe the printing process, the term jetting is also appropriate wherever ink or other liquids is applied in a consistent, metered fashion, particularly if the desired result is a thin layer or coating.

However, many other applications are emerging which use inkjet printheads to emit liquids (other than inks) that need to be finely metered and deposited with high spatial precision. Such liquids include inks, both water based and solvent based, that include one or more dyes or pigments. These liquids also include various substrate coatings and treatments, various medicinal materials, and functional materials useful for forming, for example, various circuitry components or structural components. As such, as described herein, the terms “liquid” and “ink” refer to any material that is ejected by the printhead or printhead components described below.

Inkjet printing is a non-contact application of an ink to a print media. Typically, one of two types of ink jetting mechanisms are used and are categorized by technology as either drop on demand ink jet (DOD) or continuous ink jet (CIJ). The first technology, “drop-on-demand” (DOD) ink jet printing, provides ink drops that impact upon a recording surface using a pressurization actuator, for example, a thermal, piezoelectric, or electrostatic actuator. One commonly practiced drop-on-demand technology uses thermal actuation to eject ink drops from a nozzle. A heater, located at or near the nozzle, heats the ink sufficiently to boil, forming a vapor bubble that creates enough internal pressure to eject an ink drop. This form of inkjet is commonly termed “thermal ink jet (TIJ).”

The second technology commonly referred to as “continuous” ink jet (CIJ) printing, uses a pressurized ink source to produce a continuous liquid jet stream of ink by forcing ink, under pressure, through a nozzle. The stream of ink is perturbed using a drop forming mechanism such that the liquid jet breaks up into drops of ink in a predictable manner. One continuous printing technology uses thermal stimulation of the liquid jet with a heater to form drops that eventually become print drops and non-print drops. Printing occurs by selectively deflecting one of the print drops and the non-print drops and catching the non-print drops. Various approaches for selectively deflecting drops have been developed including electrostatic deflection, air deflection, and thermal deflection.

Additionally, there are typically two types of web used with inkjet printing systems. The first type is commonly referred to as a continuous web while the second type is commonly referred to as a cut sheet(s). The continuous web refers to a continuous strip of print media, generally originating from a source roll. The continuous web is moved relative to the inkjet printing system components via a web transport system, which typically include drive rollers, web guide rollers, and web tension sensors. Cut sheets refer to individual sheets of print media that are moved relative to the inkjet printing system components via a support mechanism (e.g., rollers and drive wheels or via a conveyor belt system) that is routed through the inkjet printing system.

The invention described herein is applicable to both types of printing technologies. As such, the terms linehead and printhead, as used herein, are intended to be generic and not specific to either technology. Additionally, the invention described herein is applicable to both types of print media. As such, the terms print media and web, as used herein, is intended to be generic and not as specific to either type of print media or the way in which the print media is moved through the printing system.

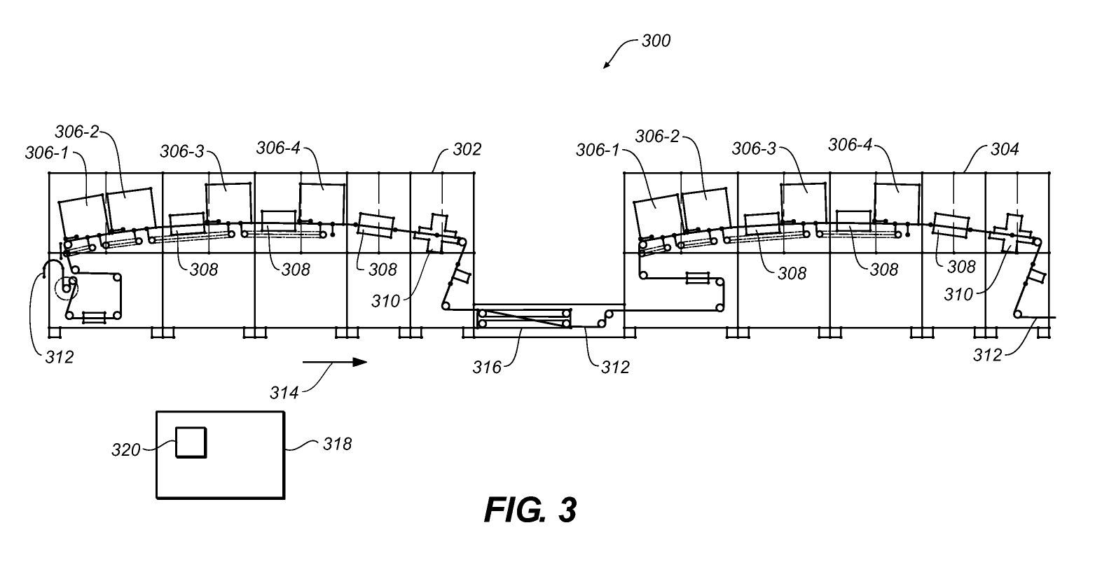

The terms “upstream” and “downstream” are terms of art referring to relative positions along the transport path of the web; points on the transport path move from upstream to downstream. In FIGS. 3-5 and 7-9 the print media moves in the direction indicated by transport direction arrow 314. Where they are used, terms such as “first”, “second”, and so on, do not necessarily denote any ordinal or priority relation, but are simply used to more clearly distinguish one element from another.

Referring now to FIG. 3, there is shown a printing system for continuous web printing on a print media in an embodiment in accordance with the invention. Printing system 300 includes a first printing module 302 and a second printing module 304, each of which includes lineheads 306, dryers 308, and a quality control sensor 310. Each linehead 306 typically includes multiple printheads (not shown) that apply ink or another liquid to the surface of the continuous web of print media 312 that is opposite the printheads. For descriptive purposes only, the lineheads 306 are labeled a first linehead 306-1, a second linehead 306-2, a third linehead 306-3, and a fourth linehead 306-4. In the illustrated embodiment, each linehead 306-1, 306-2, 306-3, 306-4 applies a different colored ink to the surface of the print media 312 that is adjacent to the lineheads. By way of example only, linehead 306-1 applies cyan colored ink, linehead 306-2 magenta colored ink, linehead 306-3 yellow colored ink, and linehead 306-4 black colored ink.

The first printing module 302 and the second printing module 304 also include a web tension system that serves to physically move the print media 312 through the printing system 300 in the transport direction 314 (left to right as shown in the figure). The print media 312 enters the first printing module 302 from a source roll (not shown) and the linehead(s) 306 of the first module applies ink to one side of the print media 312. As the print media 312 feeds into the second printing module 304, a turnover module 316 is adapted to invert or turn over the print media 312 so that the linehead(s) 306 of the second printing module 304 can apply ink to the other side of the print media 312. The print media 312 then exits the second printing module 304 and is collected by a print media receiving unit (not shown).

Processing device 318 can be connected to various components in the web tension system and used to control the positions of the components, such as the lineheads, servo motors, gimbaled or caster rollers. Processing device 318 can be connected to the quality control sensor 310 and used to process images or data received from the sensor 310. Processing device can be connected to components in printing system 300 using any known wired or wireless communication connection. Processing device 318 can be a separate from printing system 300 or integrated within printing system 300 or within a component in printing system 300. The processing device 318 can be implemented with one or more processing devices, such as a computer or a programmable logic circuit.

Connected to the image processing device 318 is one or more storage devices 320. The storage device 320 can store linehead skew adjustment values that are used by the linehead skew adjustment mechanisms to adjust the skew of one or more lineheads. The storage device 320 can be implemented as one or more external storage devices; one or more storage devices included within the processing device 318; or a combination thereof.

Although FIG. 3 depicts each printing module with four lineheads 306, three dryers 308, and one quality control sensor 310, embodiments in accordance with the invention are not limited to this construction. A printing system can include any number of lineheads, any number of dryers, and any number of quality control sensors. The printing system can also include a number of other components, including, but not limited to, web cleaners and web tension sensors.

And although the printing system shown in FIG. 3 has the turnover module 316 disposed between the first and second printing modules 302, 304, other printing systems can include the turnover module within one of the printing modules.

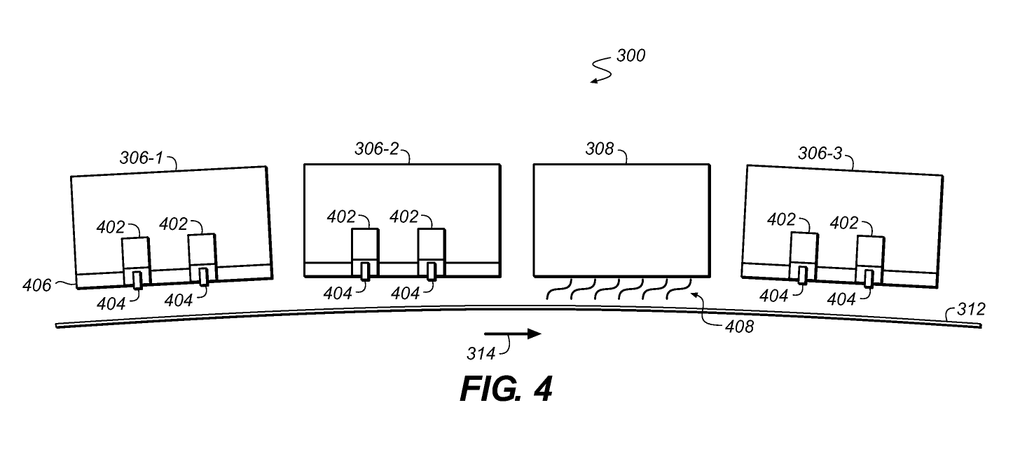

FIG. 4 depicts a portion of the printing system 300 shown in FIG. 3 in more detail. As the print media 312 is directed through the printing system 300, the lineheads 306, which typically include a plurality of printheads 402, apply ink or another liquid to the print media 312 via the nozzle arrays 404 of the printheads 402. The printheads 402 within each linehead 306 are located and aligned by a support structure 406.

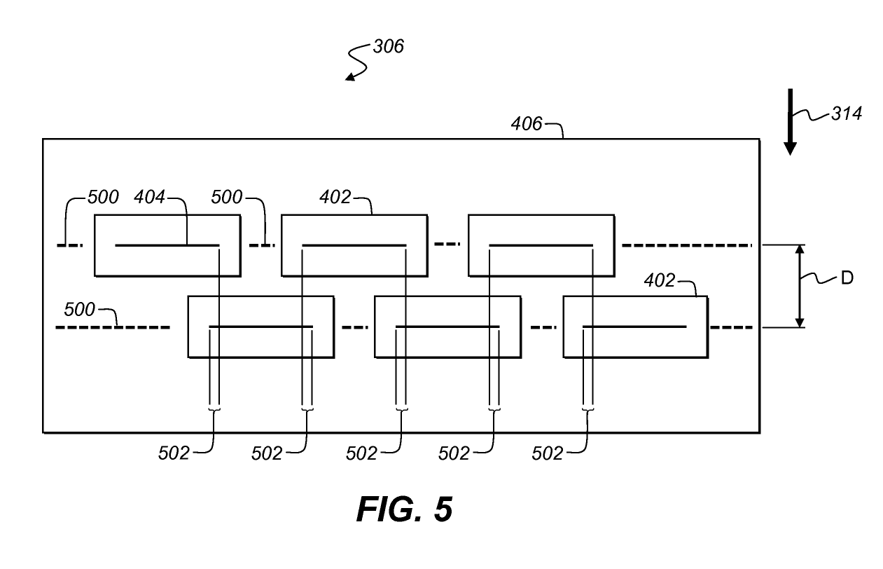

Referring now to FIG. 5, there is shown an example of an arrangement of printheads 402 in a linehead 306 in an embodiment in accordance with the invention. A face of the support structure 406 that is adjacent to the print media 312 is shown. The printheads 402 are aligned in two or more rows in a staggered formation. The nozzles arrays 404 of the printheads in each row rows of printheads 302 lie along a line, called a print line 500, which ideally is parallel to the cross-track direction and perpendicular to the direction of motion of the print media denoted by the arrow 314. The nozzle array 404 of each printhead is also aligned along the cross-track direction. As discussed earlier, the print lines are not parallel to each other and to the cross-track direction when the print media is skewed.

The print lines 500 for the rows of nozzle arrays 404 are spaced apart by a distance D. The ends of the nozzle arrays 404 of the printheads in one row overlap with the ends of the nozzles arrays of printheads in the other row or rows to produce overlap regions 504. The overlap regions 504 enable the print from overlapped printheads 402 to be stitched together without a visible seam through the use of appropriate stitching algorithms that are known in the art.

In some embodiments, the inks or liquids that are jetted from the lineheads 306 add moisture to the print media 312, which can cause the print media to expand. The added moisture also lowers the stiffness of the print media 312. And after the ink or liquid is jetted onto the print media 312, the print media 312 passes beneath the dryer 308 that applies heat 408 to the ink on the print media. Each dryer 308 drives moisture out of the print media 312, causing the print media to shrink and its stiffness to change. These changes to the print media 312 can cause the print media 312 to drift in the cross-track direction as the print media passes through each printing module in a printing system. Additionally, the width of the print media 312 as the print media exits one printing module can differ from the width of the print media 312 that entered the printing module. Drift in the print media and changes in width can make it more challenging to maintain center or edge justification of the print media as the print media travels through the printing system.

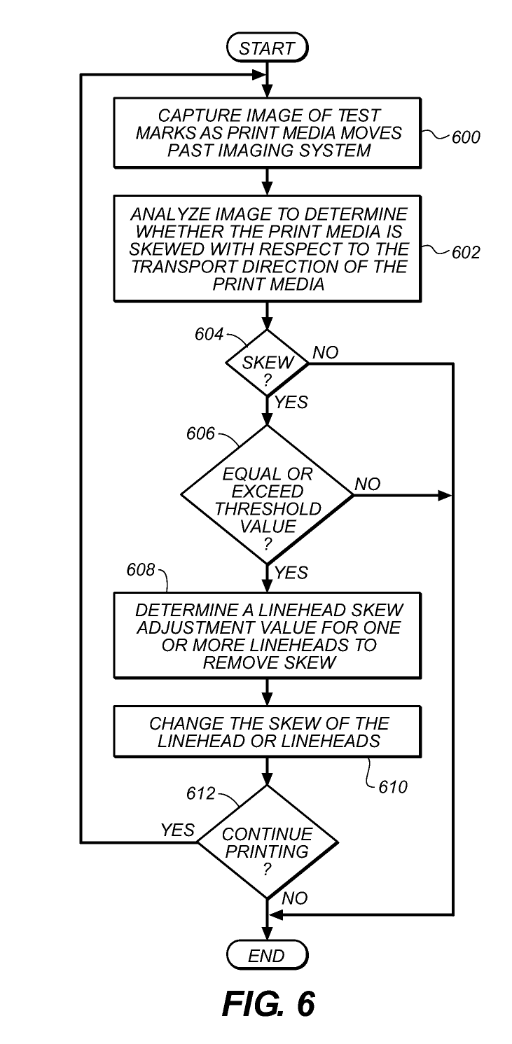

FIG. 6 is a flowchart of a method for correcting web skew in a printing system in an embodiment in accordance with the invention. Initially, one or more images of a test mark or marks is captured as the print media moves past an imaging system (block 600). By way of example only, the imaging system can be implemented as the quality control sensor 310 in FIG. 3.

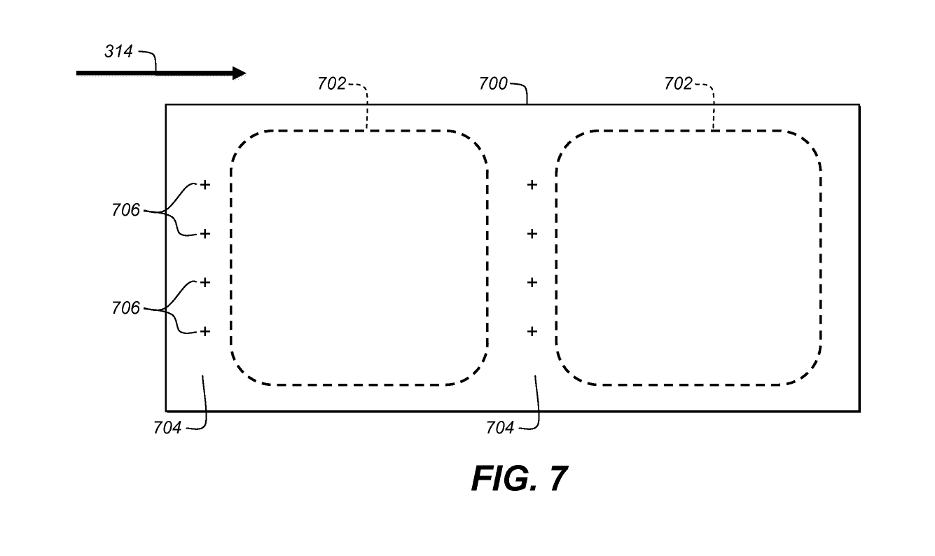

One example of test marks is depicted in FIG. 7. A print media 700 includes a content area 702 and a margin 704 that surrounds the content area 702. The content area 702 is an area on the print media where published information such as text, images, animation, and graphics will be printed on the print media. The margin 704 of the print media 700 is where non-published information is printed. In some embodiments, some or all of the non-published information is removed or cut away prior to completing a print job. Included in the margin are test marks 706 that are printed or formed on the print media. In some embodiments, each linehead prints a test mark so that all of the ink colors are used to print test marks 706 on the print media. The test marks are implemented as fiducial marks in the illustrated embodiment. Other embodiments in accordance with the invention can configure the test marks differently. By way of example only, a test mark can be one or more lines, one or more dots, one or more boxes, or one or more sets of dots with each set including one or more dots.

Returning to FIG. 6, the image of the one or more test marks is analyzed at block 602 to determine whether the print media is skewed with respect to the media transport direction (i.e., the in-track direction). In one embodiment, one test mark is used as a reference test mark and the remaining test marks are compared to the reference test mark. By way of example only, the reference test mark can be the test mark produced by the first linehead in a printing module. Typically, the print media is less likely to be skewed when the print media first enters a printing module because the print media has been aligned (e.g., center aligned) prior to entering the printing module. Also, the print media is usually dry has not experienced any expansion or stretch due as a result of jetted liquid, or contraction or shrink as a result of the dryers. In the embodiment illustrated in FIG. 3, the test mark produced by linehead 306-1 can be used as the reference test mark. Other embodiments in accordance with the invention can use a different test mark as the reference mark.

Other embodiments in accordance with the invention can determine if the print media is skewed differently. For example, the image of the one or more test marks can be compared to a reference image. The reference image can be stored in a storage device, such as storage device 320 in FIG. 3. Alternatively, the image of the one or more test marks can be compared to a reference line or box printed or formed on the print media. The position of one or both edges of the web can be determined at different locations in the printing system. By way of example only, an edge sensor can be used to determine the position of the edges of the web. And finally, the direction of the web at one or more single locations in the printing system can be determined and compared to the overall media transport direction.

A determination is then made at block 604 as to whether or not the print media is skewed. If the print media is skewed, a determination is made at block 606 as to whether or not the amount of skew equals or exceeds a threshold value. If the amount of skew equals or exceeds the threshold value, the process passes to block 608 where a linehead skew adjustment value (or values) is determined for one or more lineheads. The linehead skew adjustment value or values is used to adjust the skew of the one or more lineheads to remove, or substantially remove, the skew. By way of example only, processing device 318 (FIG. 3) can analyze the images to determine if the print media is skewed and determine the linehead skew adjustment values. The linehead skew adjustment values can be stored in a storage device, such as storage device 320 in FIG. 3.

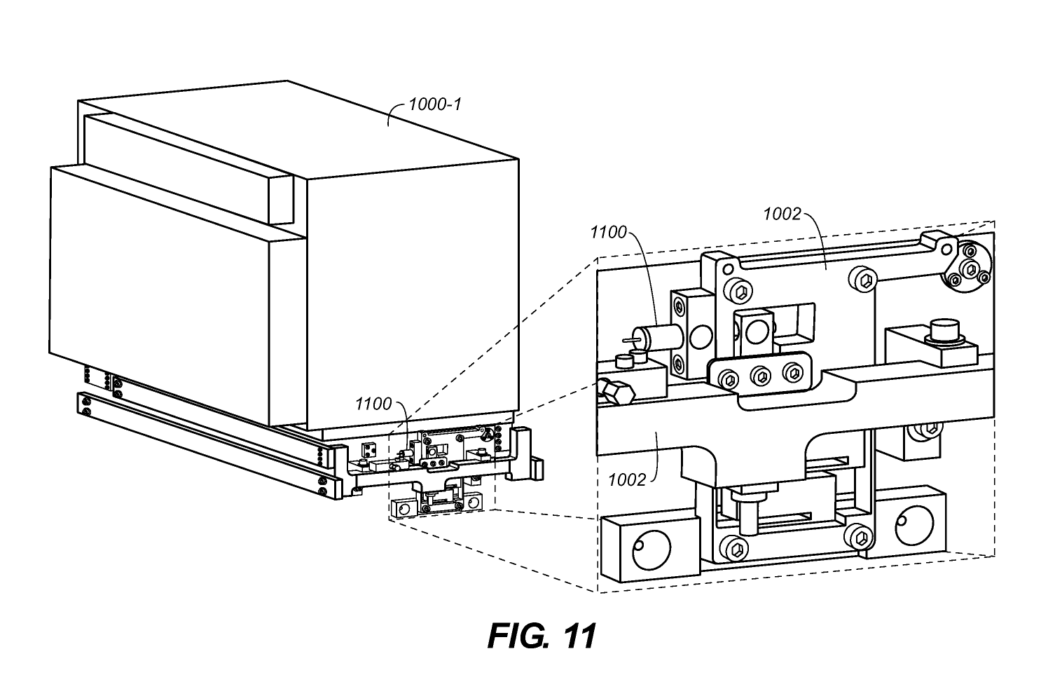

Next, at block 610, the skew of the one or more lineheads is adjusted to remove the skew of the print media. In one embodiment in accordance with the invention, the set points for one or more servo motors can be adjusted, if needed, based on the linehead skew adjustment values. The servo motors are described in more detail in conjunction with FIG. 11.

A determination is then made at block 612 as to whether or not printing on the print media is to continue. If the printing continues, the method returns to block 600 and repeats until printing is complete.

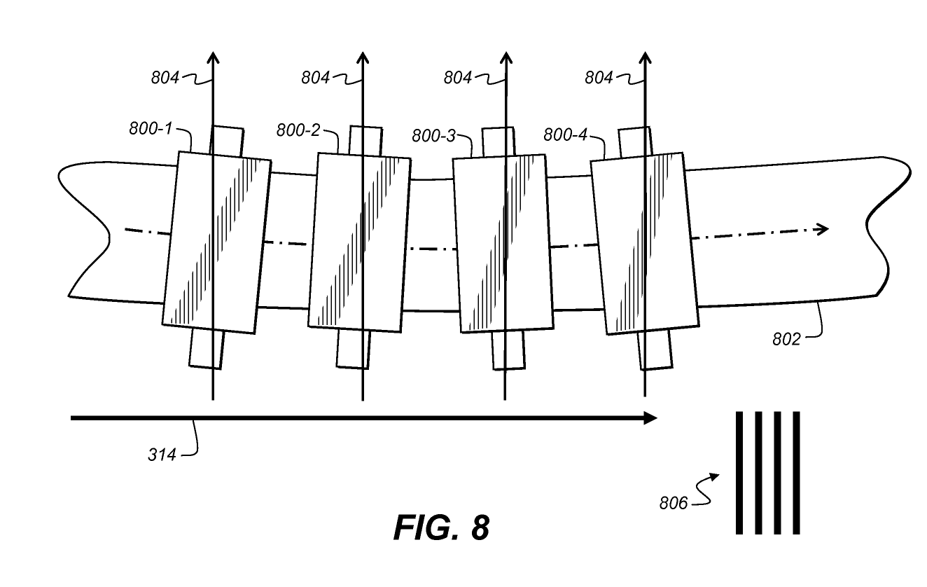

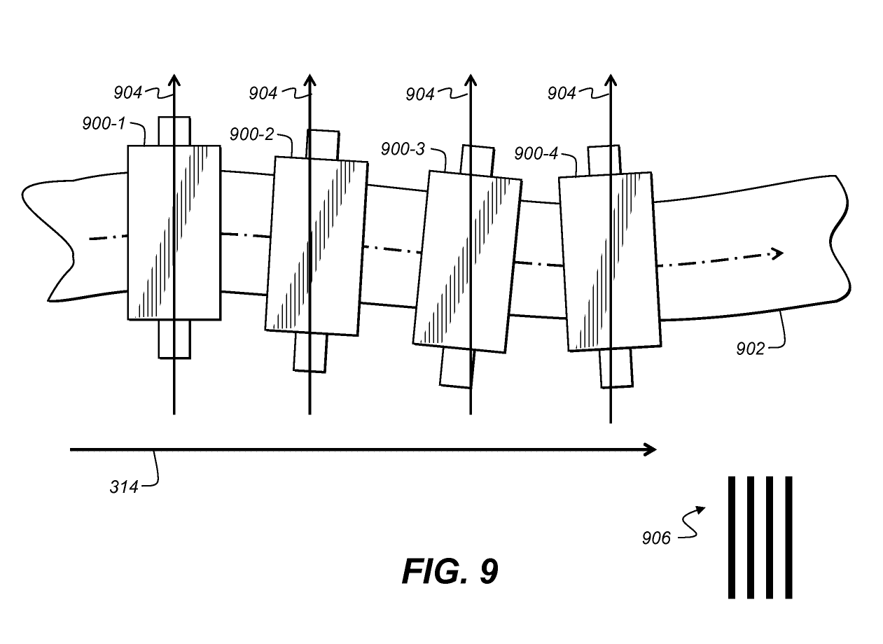

FIGS. 8-9 illustrate examples of the skew of the lineheads in a printing system after correcting for web skew in an embodiment in accordance with the invention. In the embodiment illustrated in FIG. 8, the skew of all four lineheads 800-1, 800-2, 800-3, 800-4 has be adjusted to correct for the skew in the print media 802. The lineheads 800-1, 800-2, 800-3, 800-4 are no longer positioned perpendicular to the in-track direction (feed direction 314) and parallel to the cross-track direction. Instead, each linehead is skewed with respect to line 804 (line 804 represents the cross-track direction). With the skew adjusted, the lineheads produce parallel and straight print lines 806.

FIG. 9 depicts the skew of all four lineheads 900-1, 900-2, 900-3, 900-4 after an adjustment to correct for the skew in the print media 902. The linehead 900-1 is positioned perpendicular to the in-track direction and parallel to the cross-track direction, but the other lineheads 900-2, 900-3, 900-4 are not positioned perpendicular to the in-track direction 314. With the skew of three lineheads adjusted, the lineheads produce parallel and straight print lines 906.

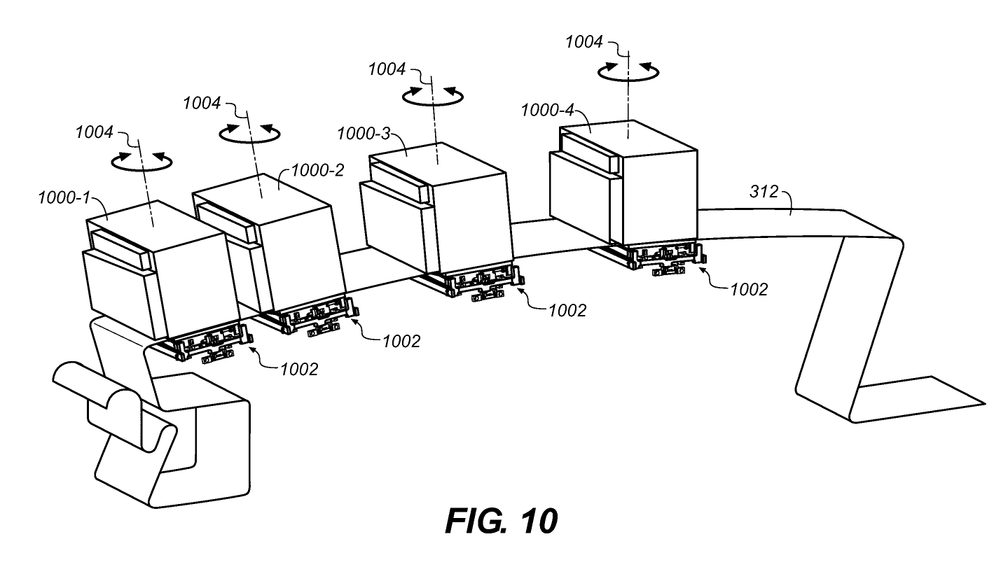

Referring now to FIG. 10, there is shown one example of the skew degree of freedom for the lineheads in a printing system in an embodiment in accordance with the invention. The print media 312 is depicted along its path of travel through the printing system 300 in FIG. 3. The lineheads 1000-1, 1000-2, 1000-3, 1000-4 each sit on a movable support 1002 in the illustrated embodiment. Each linehead can be independently moved or rotated around line 1004. By way of example only, a linehead or a moveable support can be moved or rotated +/−0.2 degrees around line 1004.

In one embodiment in accordance with the invention, the lineheads 1000 are movable in two dimensions, but not three dimensions. The lineheads 1000 cannot be positioned up or down relative to the print media. Other embodiments can move the lineheads in three dimensions to remove skew in the print media.

The skew of the lineheads 1000 is adjusted using a linehead skew adjustment mechanism 1100 (FIG. 11). The linehead skew adjustment mechanism 1100 moves or rotates the movable support 1002, which adjusts the skew of the lineheads. In the illustrated embodiment, the linehead skew adjustment mechanism is a servo motor. The configuration of the servo motor is conventional and commercially available. For example, a servo motor distributed by Ultra Motion, located in Cutchogue, N.Y. can be used as a linehead skew adjustment mechanism 1100. Alternatively, any conventional servo motor can be used provided it has the performance characteristics to make the servo motor suitable for the type of steering contemplated herein. Additionally, a stepper motor, a piezoelectric stack, pneumatics with a variable regulator, or a solenoid can be used as a linehead skew adjustment mechanism in other embodiments in accordance with the invention.

And finally, although FIG. 11 depicts only one linehead skew adjustment mechanism, two or more linehead skew adjustment mechanisms can be used to adjust the skew of one linehead in embodiments in accordance with the invention. The two or more linehead skew adjustment mechanisms can be implemented with the same type of adjustment mechanism or with different adjustment mechanisms. For example, if two linehead skew adjustment mechanisms are used, one can be a servo motor and the other a piezoelectric stack.

The invention has been described in detail with particular reference to certain preferred embodiments thereof, but it will be understood that variations and modifications can be effected within the spirit and scope of the invention. And even though specific embodiments of the invention have been described herein, it should be noted that the application is not limited to these embodiments. In particular, any features described with respect to one embodiment may also be used in other embodiments, where compatible. The features of the different embodiments may be exchanged, where compatible.

1. A method for correcting for skew in a print media in a printing system, where the printing system includes a linehead that jets ink onto a surface of the print media, an imaging system that captures images of the surface of the print media, and one or more linehead skew adjustment mechanisms adapted to adjust the skew of the linehead includes capturing images of one or more test marks printed or formed on the print media and analyzing the images to determine whether the print media is skewed with respect to a transport direction of the print media. If the print media is skewed, one or more linehead skew adjustment values are determined to adjust a skew of the linehead. The skew of the linehead is then adjusted based on the one or more linehead skew adjustment values.

2. The method as in clause 1, where analyzing the images to determine whether the print media is skewed can include comparing at least one test mark with a reference test mark.

3. The method as in clause 1 or clause 2, where the linehead is disposed on a moveable support and adjusting the skew of the linehead based on the one or more linehead skew adjustment values can include moving the moveable support based on the one or more linehead skew adjustment values.

4. The method as in any one of clauses 1-3, where the at least one linehead skew adjustment mechanism can include a servo motor and adjusting the skew of the linehead based on the one or more linehead skew adjustment values includes determining a set point for the servo motor.

5. The method in any one of clauses 1-4 can include prior to determining one or more linehead skew adjustment values to adjust a skew of the linehead, determining whether the skew of the print media equals or exceeds a threshold value. If the skew of the print media equals or exceeds a threshold value, one or more linehead skew adjustment values is determined to adjust a skew of the linehead.

6. A printing system can include a movable support and a linehead disposed on the movable support. The linehead is positioned opposite a print media and jets ink onto a surface of the print media. One or more linehead skew adjustment mechanisms is configured to move the movable support to adjust a skew of the linehead.

7. The printing system in clause 6 can include an imaging system that captures images of the surface of the print media.

8. The printing system in clause 6 or clause 7 can include a processing device adapted to analyze the images captured by the imaging system. The processing device can be connected to the imaging system.

9. The printing system in any one of clauses 6-9 can include a storage device. The storage device can be connected to the processing device.

### PARTS LIST

100 print media
102 media operation zone
104 center line of print media
106 linehead
108 print lines
200 print lines
300 printing system
302 printing module
304 printing module
306 linehead
308 dryer
310 quality control sensor
312 print media
314 feed direction
316 turnover module
318 processing device
320 storage device
402 printhead
404 nozzle array
406 support structure
408 heat
500 print line
502 overlap region
700 print media
702 content area
704 margin
706 test marks
800 linehead
802 print media
804 line perpendicular to feed direction
806 print lines
900 linehead
902 print media
904 line perpendicular to feed direction
906 print lines
1000 linehead
1002 moveable support
1004 axis for skew adjustment
1100 linehead skew adjustment mechanism
D distance

1. A printing system, comprising:
a movable support;
a linehead disposed on the movable support, wherein the linehead is positioned opposite a print media and jets ink onto a surface of the print media; and
one or more linehead skew adjustment mechanisms configured to move the movable support to adjust a skew of the linehead.

2. The printing system as in claim 1, further comprising an imaging system that captures images of the surface of the print media.

3. The printing system as in claim 2, further comprising a processing device connected to the imaging system.

4. The printing system as in claim 3, further comprising a storage device connected to the processing device.
